(19) United States
(12) Patent Application Publication
(10) Pub. No.: US 2005/0046231 A1
(43) Pub. Date: Mar. 3, 2005

(54) Step attachment

(76) Inventor: Frank Fusco, Schaefferstown, PA (US)

Correspondence Address: FRANK FUSCO, P.O. BOX 193, SCHAEFFERSTOWN, PA, 17088, US

(21) Appl. No.: 10/647,871

(22) Filed: Aug. 26, 2003

(51) Int. Cl. B60P 3/37

(52) U.S. Cl. 296/162

(57) ABSTRACT

A step attachment for travel trailer and such foldeing steps that can be assembled when travel trailers and such get to the R.V. park and disassemled at the time the travel trailer and such is readying to leave for the next R.V. park. The step attachment going over the folding steps of the R.V. making the folding steos of the R.V. much stronger and adding a handrailing for safety.

In travel trailers—fifth wheels—motor home and such have step that fold in when vehicle is in movement and fold out when vehicl is park and being usrd to enter trailers and such.

The step attachment that will be assemble over the vehicles folding steps when park and disassembled when vehicle is in movememt the step attachment will make the R.V. folding steps much stronge and adding a handrailing to the vehicle folding steps.

The step attachment is a advantage and improvement over the folding steps of the R.V. by makeing the R.V. steps much stronger and adding a handrailing for safety.

### BACKGROUND

The step attachment relate to folding steps of a R.V. that have steps that fold in when the R.V. vehicle is in movement and fold out when R.V. vehicle is park to enter the R.V. that have folding steps that are not to strong or steady.

The step attachment going over the R.V. folding steps will make the R.V. R.V. folding steps much stronger and by adding a hand railing making it safer to enter and leaving the R.V. for senior citizens and others.

That is an improvement over the R.V. folding steps.

### SUMMARY

The advantage of the step attachment is that it will make the folding steps of the R.V. vehicle much stronger and safer by adding a handrailing to the R.V. and can be assemvled and disassembled easily at any time for many older senior citizens that have many R.V. at this time.

That is an improvement over the R.V. folding steps.

### BRIEF DESCRIPTION OF DRAWINGS

FIG. 1 Showing step attachment #3 attach to handrailing #4 and #2 attach to #3 and showing ajustment nut & bolt #1

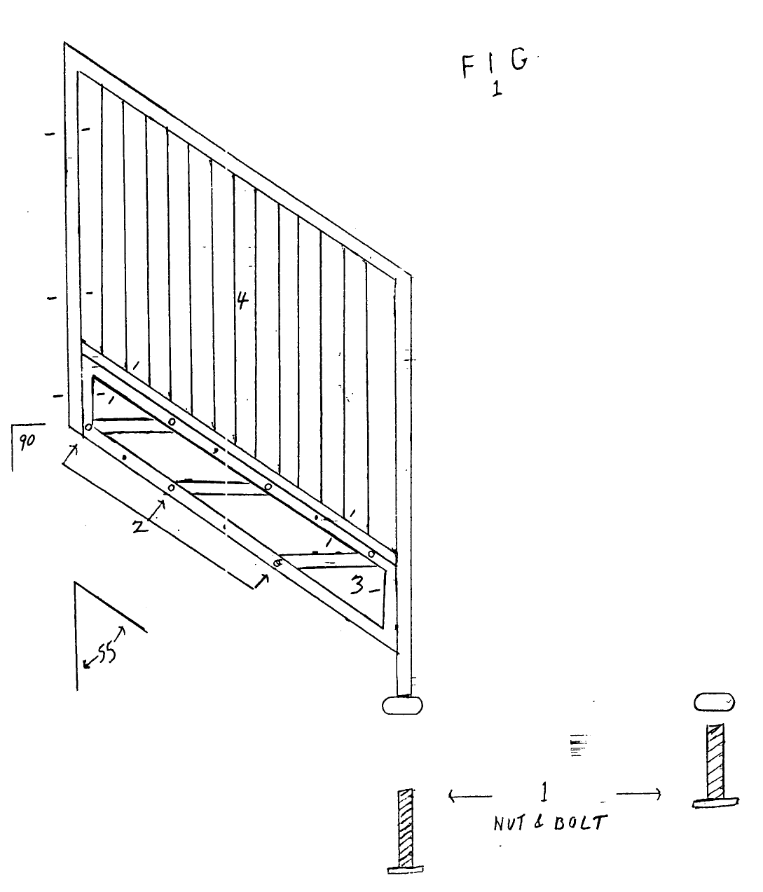

FIG. 2 showing top and side view of support brace #2

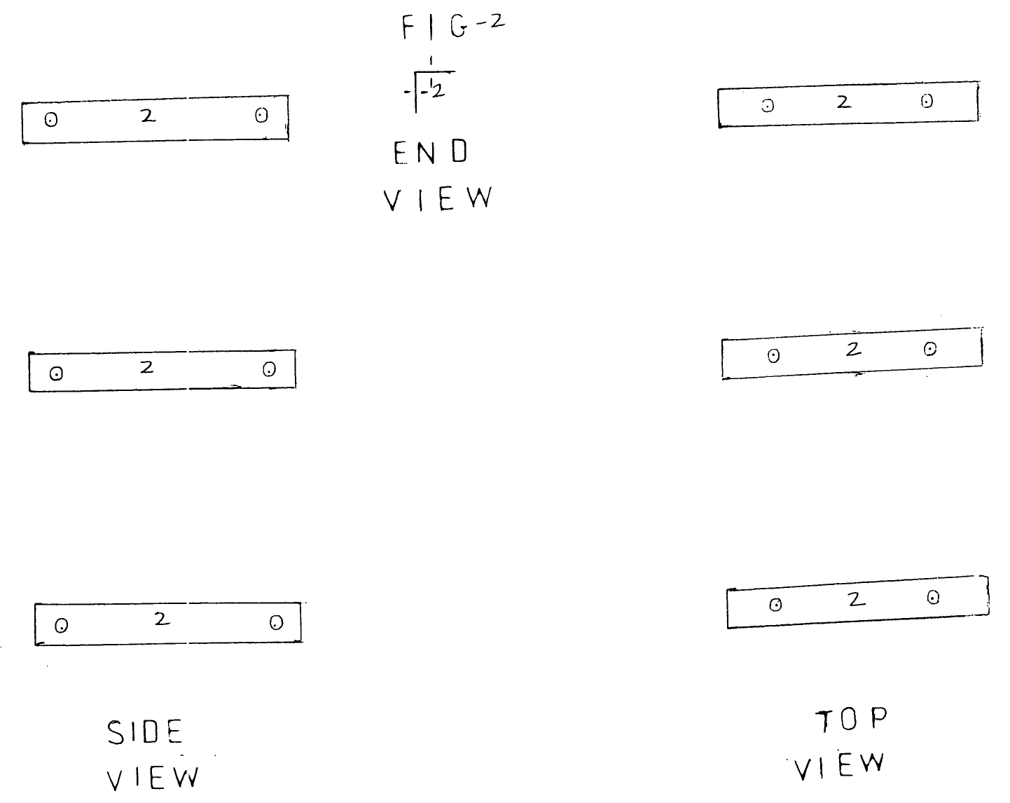

FIG. 3 showing step attachment #3

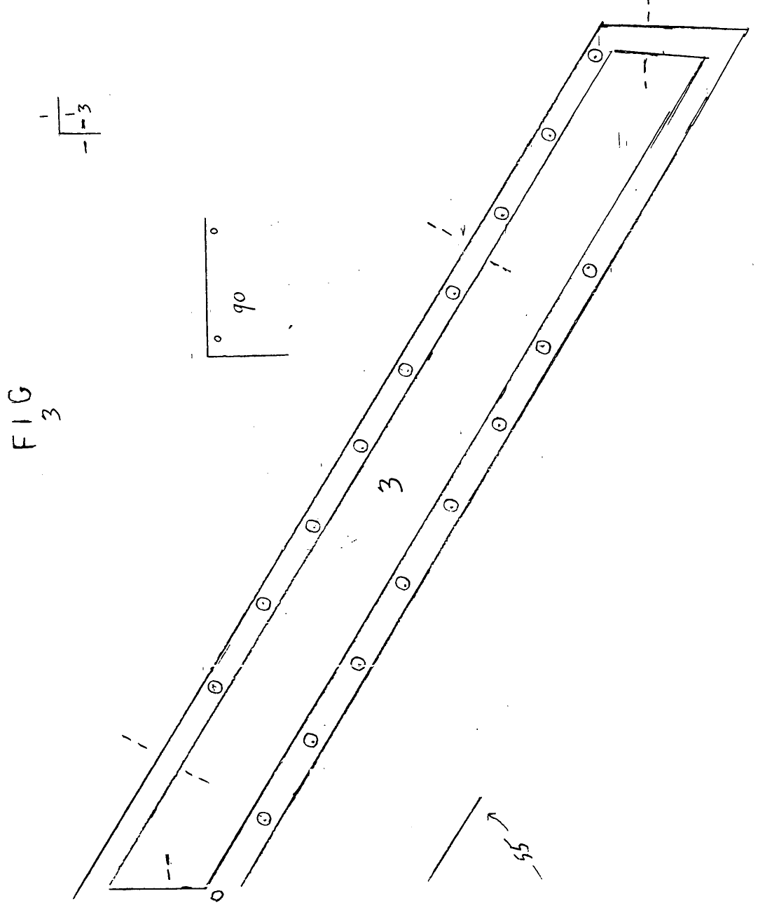

FIG. 4 showing wooden step thats going over R.V. folding steps and holes were thay are attach to folding steps & support brace #2

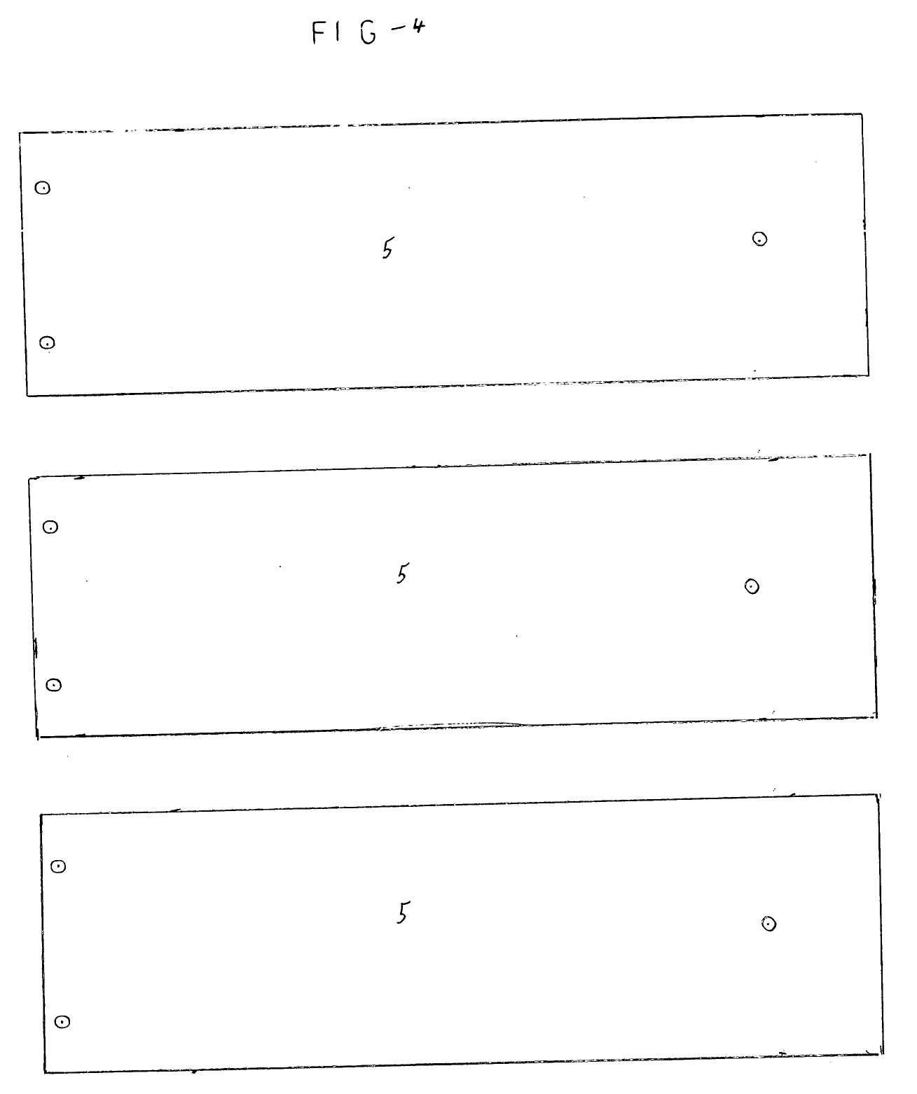

FIG. 5 showing photos of befor and after of folding steps of R.V. and step attachment attach to R.V. steps

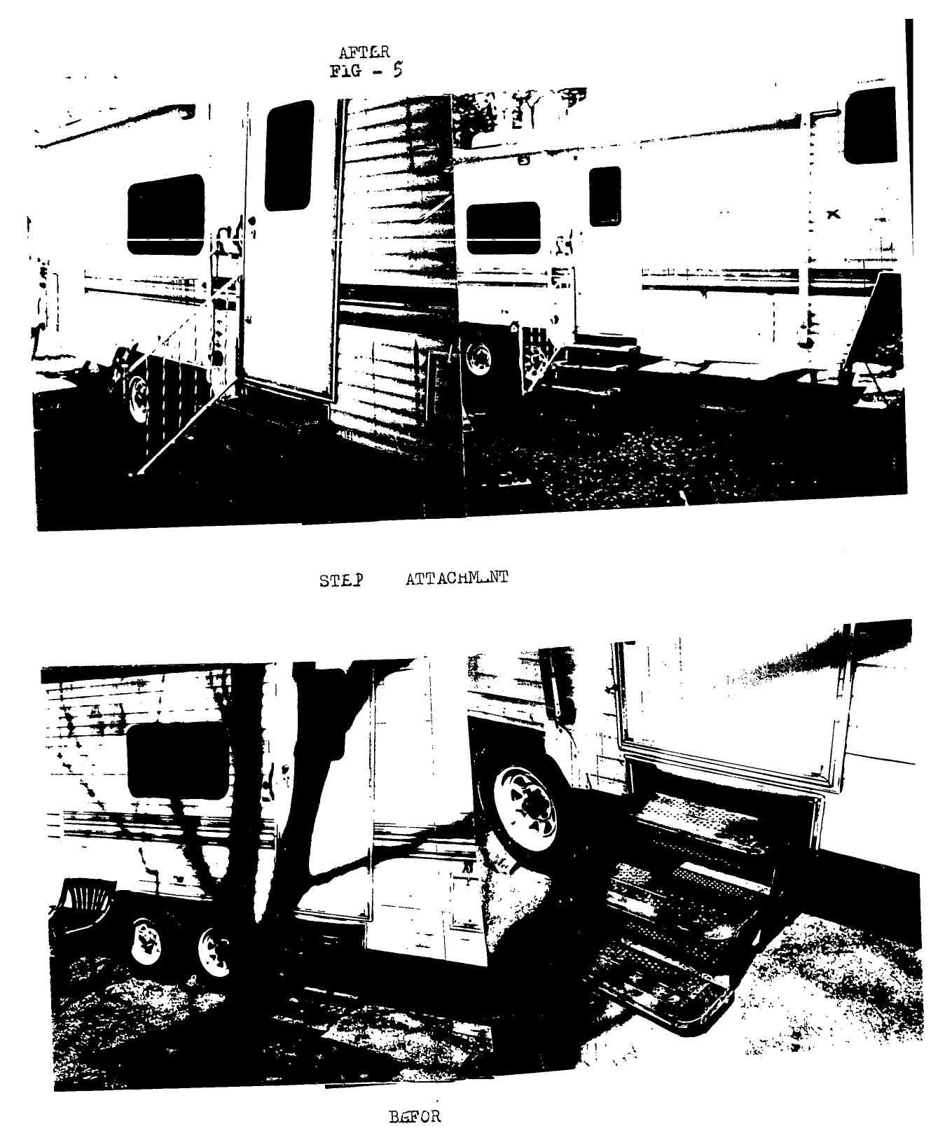

### DETAILED DESCRIPTION

The folding steps of an R.V. that the step attachment that will go over the R.V. folding steos that will make the folding steps of the R.V. much stronger and safer.

An improvement then just having the folding steps of the R.V. that are not to strong or steady

The step attachement that can be assembled and disassembled easily at any time

By removing or adding wingnuts to stationary bults 3 on each step and 3 on handrailing #4 the end that is attach to the R.V. vehicle

1. A step attachment that can be attach to a handrailing that then can be attach and ajusted to any travel trailers and such that can be assembled and disassembled at any time for trael trailer steps and such.
